(19) United States
(12) Patent Application Publication
(10) Pub. No.: US 2005/0022150 A1
(43) Pub. Date: Jan. 27, 2005

(54) OPTICAL PROXIMITY CORRECTION METHOD

(76) Inventors: Shu-Hui Liu, Nan-Tou Hsien (TW); Wen-Bin Wu, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,244

(22) Filed: Dec. 1, 2003

(30) Foreign Application Priority Data
Jul. 23, 2003 (TW) 092120144

(51) Int. Cl. G06F 17/50; G03C 5/00

(52) U.S. Cl. 716/19; 716/21; 430/30

(57) ABSTRACT

An optical proximity correction (OPC) method for correcting a photomask layout. The photomask layout has at least a photomask pattern. The steps of the OPC method include collecting an assist feature bias of a predetermined assist feature, performing a rule-based OPC by taking account of the assist feature bias to compute a target bias of the photomask layout, outputting a corrected photomask layout according to the target bias, and adding the predetermined assist feature to the corrected photomask layout.

### BACKGROUND OF INVENTION

1. Field of the Invention

The invention relates to an optical proximity correction (OPC) method for correcting a photomask layout, and more particularly, to an OPC method of adding scattering bars to the photomask layout after a rule-based OPC process.

2. Description of the Prior Art

In semiconductor fabrication, the method for transferring a pattern of integrated circuits to a semiconductor involves outputting a photomask layout of the circuit design, producing a photomask with the photomask patterns according to the photomask layout, and exposing the photomask pattern to a semiconductor substrate in predetermined ratio.

The critical dimension (CD) of the designed photomask pattern is limited by the resolution limit of the optical exposure tool, so that an optical proximity effect (OPE) easily occurs when high-density photomask patterns of high circuit integration are exposed to the semiconductor substrate. OPE causes deviation when transferring the photomask patterns. For example, right-angled corner rounding, line end shortening, and line width increasing/decreasing are common defects caused by OPE.

To prevent the defects of the photomask pattern caused by OPE, an OPC process is preformed. The OPC process uses a computer aided design (CAD) with exposing parameters and a calculation software to correct the original photomask pattern of the original photomask layout and create a corrected photomask layout. The corrected photmask layout is then input into a computer to produce a photomask. The produced photomask according to the corrected photomask layout can be exposed to form a transferred pattern on the semiconductor substrate similar with the original photomask layout.

The OPC process can be performed using a model-based OPC or a rule-based OPC. The model-based OPC process comprises exposing a test photomask to compare the resuit with the original photomask pattern so as to build an OPC model. A simulation tool is used to make a complicated calculation by taking into account the illumination conditions and parameters of the exposed pattern of the test photomask. However, a large amount of time is required to make the comparison, calculation, and simulation of the test photomask pattern and the original photomask pattern. Therefore the model-based OPC process is not efficient.

In the other hand, the rule-based OPC process uses a database to get a target bias to correct the density and spacing between the photomask patterns. The advantage of the rule-based OPC process is that the target bias can be easily found by searching an appropriate parameter combination from the database. However, when the parameter combination cannot be matched in the database, the target bias has to be calculated through interpolation of the closet parameter and correction condition. In contrast to model-based OPC, rule-based OPC rapidly computes the target bias to correct the photomask layout, but rule-based OPC may have greater errors resulting from interpolation and unsuitability of functions so that the reliability of the corrected photomask layout is decreased.

Please refer to FIG. 1, which is a flow chart of an OPC process 100 using rule-based OPC method according to the prior art. The OPC process 100 comprises the following steps:

Step 102: Expose a test photomask on a semiconductor to observe a bias table of width and spacing of the exposed pattern on the semiconductor.

Step 104: Perform a rule-based OPC process to add a target bias to the original photomask layout according to the bias table in step 102.

Step 106: Output the corrected photomask layout of step 104 to produce a photomask.

Presently, compact calculation software is generally used to perform the rule-based OPC process, and the input information of the compact calculation software has to be in a specific format. Therefore, after step 102 is performed, a computer program may be used to change the format of the bias table of the test photomask, and then the bias table with the changed format is input to the compact calculation software for performing the rule-based OPC process. The OPC process 100 corrects the photomask layout to gain a better process window by adding a target bias in the cases having greater spacing for both dense lines or isolated lines. However, when the spacing becomes smaller, the process window of the isolation region cannot be improved by adding the target bias from rule-based OPC. As a result, it is not sufficient to use a conventional rule-based OPC process to correct a photomask layout in a high integration condition.

As a result, a common OPC method of semiconductor manufacturers is to first add scattering bars to the original photomask layout, and then to perform a model-based OPC process. Please refer to FIG. 2. FIG. 2 is an OPC process 200 using scattering bars and then a model-based OPC method, wherein the original photomask layout comprises a plurality of photomask patterns. The OPC process 200 comprises the following steps:

Step 202: Calculate parameters of predetermined scattering bars and add the predetermined scattering bars to the original photomask layout.

Step 204: Build an OPC model according to the photomask layout with scattering bars.

Step 206: Perform a model-based OPC process to add a target bias to each of the photomask patterns of the photomask layout with scattering bars.

Step 208: Output the corrected photomask layout to produce a photomask.

The scattering bar is an assist feature for increasing the process window. For example, a scattering bar can be added to a constant distance of the spacing between each of the lines of an isolation region to raise contrast and resolution, so that the isolation region and dense region can have a common process window with the same exposed performance. However, the scattering bars added in the beginning are corrected together during the model-based OPC step in the OPC process 200. The final result will therefore fail to meet the target CD because the spacing between each of the photomask patterns and each of the scattering bars changes during the model-based OPC to cause each process window of each photomask pattern to become indefinite. The process window may even exceed the limit of adding scattering bars and result in the scattering bars being exposed on the semiconductor. In addition, since the OPC process 200 uses the model-based OPC method, it still takes a large amount of time to get the corrected result.

In summary, the prior-art OPC method cannot effectively correct a photomask pattern with high density and may still cause deviations when the corrected photomask pattern is exposed on a semiconductor substrate.

### SUMMARY OF INVENTION

It is therefore a primary objective of the claimed invention to provide an OPC method that first performs a rule-based OPC process and then manually adds assist features to solve the above-mentioned problem.

According to the claimed invention, an OPC method is disclosed for correcting a photomask layout wherein the photomask layout has at least a photomask pattern. The method comprises: collecting an assist feature bias of a predetermined first assist feature which will be added to the photomask layout; performing a rule-based OPC process by taking into account the assist feature bias to compute a target bias of the photomask layout for correcting the original photomask layout and output a corrected photomask layout according to the target bias; and adding the first assist feature to the corrected photomask layout. The first assist feature is capable of being a scattering bar.

According to the present invention, the rule-based OPC process comprises: collecting a width and a spacing of the photomask pattern to obtain a parameter of the photomask pattern; adding a second assist feature to the photomask pattern using a correction rule of a database according to the parameter of the photomask pattern for correcting an edge portion of the photomask pattern. The second assist feature is capable of being a serif or a hammerhead pattern.

Since the present invention OPC method adds scattering bars to the photomask pattern after the rule-based OPC process, the CD of the photomask pattern meets the target CD of the fabrication. Furthermore, the spacing between the scattering bars and the photomask patterns can be fixed to allow the advantage of the scattering bars raising the resolution and process window of isolated lines. In addition, the rule-based OPC process can be easily performed. Therefore, the present invention OPC method effectively corrects a photomask layout to gain a more accurate exposed photomask pattern.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flow chart of an OPC process using the rule-based OPC method according to the prior art.

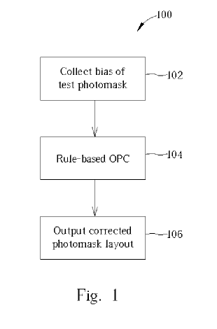

FIG. 2 is a flow chart of an OPC process using scattering bars and the model-based OPC method.

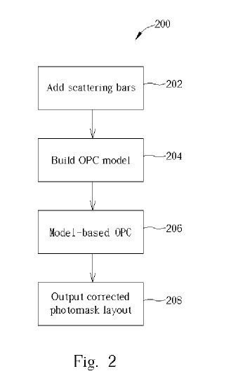

FIG. 3 is a flow chart of an OPC process of the OPC method according to the present invention.

### DETAILED DESCRIPTION

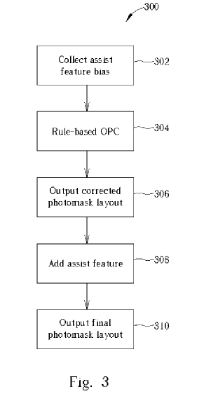

Please refer to FIG. 3, which is an OPC process 300 of the OPC method according to the present invention, wherein the photomask layout comprises at least a photomask pattern. The OPC process 300 comprises the following steps:

Step 302: Collect an assist feature bias (bias table) of a predetermined first assist feature which will be added to the photomask layout to build an assist feature correction model or a database, and collect the exposed bias of the original photomask pattern. The first assist feature may be a scattering bar. In this step, a test photomask may be used to calculate the appropriate location and dimensions of the scattering bar.

Step 304: Perform a rule-based OPC by taking into account the assist feature correction model or the database from the step 302 to add a target bias to the original photomask pattern. In this step, the test photomask may still be used to see if the exposed result matches the ideal performance. The rule-based OPC process uses a compact software, such as Niagara, to compute the target bias, and therefore a specific program, such as Buffalo program, may be used to transfer the collected assist feature bias (bias table) to the specific format for the compact software of the rule-based OPC after step 302.

Step 306: Output the corrected photomask layout corrected by the computer.

Step 308: Add the first assist feature of step 302 to the corrected photomask layout by using a physical verification tool, such as a design rule checker (DRC), or other supported software.

Step 310: Output the result of step 308, and produce a photomask according to the result of step 308.

The rule-based OPCprocess of step 304 comprises collecting the width and spacing between the photomask pattern of the original photomask layout to gain parameters of the photomask pattern, and computing the target bias of the photomask pattern according to the parameters of the photomask by using a correction rule of a database. In general, the rule-based OPC of step 304 is used for correcting edge portions of the photomask pattern, and the correction result of the rule-based OPC is to add at least a second assist feature to the photomask pattern in a right-angled corner or a line end. The second assist feature may be a serif or a hammerhead pattern. The second assist feature improves defects in prior art such as right-angled corner rounding, line end shortening, and line width increasing/decreasing.

In contrast to the prior art, the present invention OPC method comprises: considering parameters of the photomask pattern of the original photomask layout and the first predetermined assist features, such as scattering bars, together in the beginning. A rule-based OPC process is then performed to add second assist features to the original photomask layout to observe a corrected photomask layout. Finally, the first assist features are added to the corrected photomask layout. According to the present invention, the scattering bars added last are not corrected by the rule-based OPC process, and therefore, the spacing between the scattering bar and the photomask pattern can be effectively controlled during the whole correction process. As a result, the limitation of scattering bars of the prior art, for example, a scattering bar may be exposed on a semiconductor substrate, can be solved. Furthermore, the parameters of scattering bars are taken into account and input into the rule-based OPC software in the beginning of the process. In this way, the scattering bars last added to the photomask layout result in a preferable exposing effect, especially improving the process window of the isolation region. In addition, the present invention OPC method adopting the rule-based OPC process to correct the original photomask layout efficiently and simply in cooperation with the first assist feature, such as scattering bars, has a better critical dimension so as to raise the contrast and resolution, and further improve the yield of the product.

Those skilled in the art will readily observe that numerous modifications and alterations of the device may be made while retaining the teachings of the invention. Accordingly, the above disclosure should be construed as limited only by the metes and bounds of the appended claims.

1. An optical proximity correction (OPC) method for correcting a photomask layout, wherein the photomask layout comprises at least a photomask pattern, the OPC method comprising:
collecting an assist feature bias of a predetermined first assist feature which will be added to the photomask layout;
performing a rule-based OPC process by taking account of the assist feature bias to compute a target bias of the photomask layout and output a corrected photomask layout according to the target bias; and
adding the first assist feature to the corrected photomask layout.

2. The OPC method of claim 1, wherein the first assist feature is a scattering bar.

3. The OPC method of claim 1, further comprising using the collected assist feature bias to build an assist feature correction model for the rule-based OPC process.

4. The OPC method of claim 1, further comprising transferring the collected assist feature bias to a specific format for the ruled-based OPC process.

5. The OPC method of claim 1, wherein the rule-based OPC process is used for correcting an edge portion of the photomask pattern.

6. The OPC method of claim 1, wherein the rule-based OPC process comprises:
collecting a width and a spacing of the photomask pattern to obtain a parameter of the photomask pattern; and
adding a second assist feature using a correction rule of a database according to the parameter of the photomask pattern.

7. The OPC method of claim 6, wherein the second assist feature is a serif or a hammerhead pattern.
